(19) United States
(12) Patent Application Publication
(10) Pub. No.: US 2004/0173463 A1
(43) Pub. Date: Sep. 9, 2004

(54) Method for production of printed wiring board

(76) Inventors: Jin-ichi Itoh, Tokyo (JP); Yasuaki Nishio, Shiga (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/483,557

(22) PCT Filed: Jul. 12, 2002
(86) PCT No.: PCT/JP02/07121

(30) Foreign Application Priority Data
Jul. 13, 2001 (JP) 2001-213446

(51) Int. Cl. H01M 4/86

(52) U.S. Cl. 205/133; 429/41

(57) ABSTRACT

The present invention provides the development of techniques for development and removal of a resist in place of conventional chemicals, and the techniques to present pollution-free treatment of discharged water involved in this removal technique. Namely, the removal of an uncured resist after exposure of a board 40 is conducted by preferably immersing the board in a sodium carbonate solution tank 42, and then using an electrolyzed alkaline water by a showering apparatus 44, etc.; and the removal of a cured resist after etching is conducted by preferably swelling the cured resist by means of a sodium hydroxide solution and then using an electrolyzed alkaline water. Further, to a resist discharged water containing resist residues removed from the board 40 by means of the electrolyzed alkaline water, the electrolyzed acidic water is mixed to acidify the discharged water to a neutral to weekly acidic range, and then the resist residues are collected and recovered by means of a filter.

### TECHNICAL FIELD

The present invention relates to a method for producing a printed-wiring board; more particularly, to a method of improvement in development of a photosensitive resist film and removal thereof in steps of forming a patterned copper, and a method of improvement in development of a photosensitive resist film in steps of forming a photosensitive insulation layer; and further a method for reutilizing waste water generated in these steps.

### BACKGROUND ART

As typical steps for forming electrically conductive copper pattern electrodes on a circuit board as an electronic part, formation of a copper film by e.g. plating on a board surface, pretreatment, formation of a photosensitive resist film by coating or lamination, exposure with a mask interposed, development of the resist (formation of cured resist images by removal of uncured resist), etching of exposed copper film portions, and peeling (removal) of cured (photosensitive) resist, etc. may be mentioned.

Further, a photosensitive insulation layer may sometimes be formed on the surface of the formed copper pattern electrodes, and in such a step, the same steps as the formation of patterned electrodes such as coating, exposure and development of a photosensitive resist, may be included. And, in these processing steps including, particularly, from the development of the resist and/or the removal thereof to the treatment of the waste water, treatments on the basis of chemical reactions by means of a large amount of chemicals are incorporated.

On the other hand, problems of pollution of terrestrial environment have been raised to the surface. To cope with such problems, in air pollution, prohibition of use of trichloroethane and trichloroethylene as causes of ozone layer depletion; and in pollution of river water, standard of industrial liquid waste, regulations of industrial waste, etc. have been legislated to protect the environment. However, there is a limit in satisfying the pollution standard of COD and BOD by dilution with a large quantity of water, whereby regulation of total emission of the industrial waste liquor has been introduced and the production of the printed-wiring boards has been limited by necessity. Accordingly, it has been demanded to restudy the processing methods presently used by means of chemicals only, and the problems in question can not be solved by conventional techniques only.

In this regard, analyzing the process for production of the printed-wiring board in a little more detail, the development of the photosensitive resist, the etching, and the peeling (removal) of the resist, include particularly the treatments with chemicals. Among them, the etching is mainly made with ferric chloride, and problems are solved by providing a closed system from the supply of the etching liquid to the discharge thereof, thereby reutilizing the liquid.

However, in the development of the resist and/or removal thereof, since the resist is dissolved by an alkaline chemical, a large quantity of organic substances such as the residue of resist is contained in the waste water, and high costs have been required for treatment of the waste water. Further, a rinsing water is used for cleaning of alkali chemicals after the removal of the resist, and a large quantity of city water or well water has been used for rinsing. However, regulations for total emission of discharged water from factories have recently been introduced to prevent the progress of eutrophication of lakes, whereby development of techniques for recycling the discharged water have strongly been demanded.

However, the development of the resist and/or removal thereof are completed processing techniques with chemicals, and a higher technical level is necessarily required for their substitute techniques. Accordingly, sufficiently satisfactory techniques have not yet been developed by now.

### DISCLOSURE OF THE INVENTION

In order to solve the above problems, the present inventors have noticed that development of a new technology for the development of a resist and/or removal thereof is required instead of the conventional ones with chemicals, and development of a new technique for changing the treated water discharged from this step to a pollution-free water, and to a level of city water standard for reutilization. The present inventors have made extensive studies on the basis of this concept, and reached the present invention.

Accordingly, it is an object of the present invention to provide the development of a technique for development of a resist and/or removal thereof instead of the ones with chemicals, and further a technique for reducing the load of the treatment of discharged water involved in this technique.

Namely, the first aspect of the present invention is to provide a method for producing a printed-wiring board, which is characterized by that in production steps of a printed-wiring board, a development of a photosensitive resist and/or a removal thereof, or a formation of a photosensitive insulation layer is conducted with an electrolyzed alkaline water (hereinafter referred to as Step 2 or Step 4).

First, in the present invention, the development of the photosensitive resist means that an uncured resist after the exposure (an exposed portion in a positive type resist, and an unexposed portion in a negative type resist) is dissolved for removal, to form a resist pattern. Further, the removal of the photosensitive resist mainly means that after the etching, a resist attached to the surface of a conductive pattern is peeled off. Further, the formation of the photosensitive insulation layer means a step in which a photosensitive resin is coated on the surface of the formed conductive pattern, and then sensitized for curing (development).

As described above, the basis of the present invention resides in the use of an electrolyzed alkaline water in the development of the photosensitive resist and/or the removal thereof, or the formation of the photosensitive insulation layer. This is one of a series of results of the present inventors' researches for a long time on the electrolyzed alkaline water and electrolyzed acidic water obtainable by electrolysis of water.

According to the first aspect, unlike the conventional treatment with chemicals, the development of the resist and/or the removal thereof is conducted with the electrolyzed alkaline water which is basically made from water, whereby the treatment of discharged water can be made easily and the reutilization of the discharged water can be made possible.

The second aspect of the present invention is to provide a method wherein in the development of the resist, removal of an uncured resist is conducted with the electrolyzed alkaline water (hereinafter referred to as Step 2). The second aspect provides a method for removing the uncured resist in which the treatment of discharged water can be made easily.

The third aspect of the present invention is to provide a method wherein in the development of the resist, the removal of the uncured resist is conducted by swelling the uncured resist with an alkaline chemical such as sodium carbonate (hereinafter referred to as Step 1), and then removing the uncured resist with the electrolyzed alkaline water (Step 2). Namely, the third aspect of the present invention is conducted by combining at least the Step 1 and Step 2.

According to the third aspect, since the alkaline chemical such as sodium carbonate as one of conventional chemicals is used only for the Step 1 and the electrolyzed alkaline water is used for the Step 2, the Step 2 can be made efficiently, and at the same time, it contributes to prolonged lifetime of chemical liquor and reduction of chemical costs.

Here, as the alkaline chemical, a sodium carbonate solution is preferably used for the following reason. Since the photosensitive resin as the resist commonly has a carboxylic group, sodium ions will bond to the carboxylic group, and the photosensitive resin becomes water-soluble and tends to be soluble in the electrolyzed alkaline water. Here, other than the sodium carbonate solution, any ones capable of swelling the resist can be used. For example, a sodium hydroxide solution may be used. However, if the pH is high, the resist is unfavorably peeled off, and the control of the development time is difficult. Further, in European countries, potassium carbonate may sometimes be used.

The fourth aspect of the present invention is a method wherein the removal of the cured resist after the etching is conducted with the electrolyzed alkaline water (hereinafter referred to as Step 4). According to the fourth aspect, it is possible to provide a method for removing the cured resist in which the treatment of the discharged water can be made easily.

The fifth aspect of the present invention is a method wherein the removal of the cured resist after the etching is conducted by swelling the cured resist with an alkaline chemical such as sodium hydroxide (hereinafter referred to as Step 3), and then removing the cured resist with the electrolyzed alkaline water (Step 4). The basis of the fifth aspect of the present invention resides in that at least the Step 3 and Step 4 are combined as mentioned above.

According to the fifth aspect, since the alkaline chemical such as sodium hydroxide solution is used only for the Step 3 and the electrolyzed alkaline water is used for the Step 4, the removal of the cured resist as the Step 4 can be made efficiently as in the second aspect of the present invention, and at the same time, it contributes to prolonged lifetime of chemical liquor and reduction of chemical costs.

Here, as the alkaline chemical, a sodium hydroxide solution is preferably used for the following reason. Since the time required for the swelling of the cured resist is short by use of this solution, and since the cured resist must be peeled off completely in this step, a strong peeling power is required. Further, this aspect is advantageous from the viewpoints of costs.

As mentioned above, at first, the removal of the uncured resist after the exposure is made by the Step 2 via the Step 1, and further in the case of the formation of the pattern, the removal of the cured resist after the etching is conducted by the Step 4 via the Step 3, whereby the development of the resist and/or the removal thereof can be made efficiently.

The sixth aspect of the present invention is to provide a method wherein the electrolyzed acidic water is blended with a resist discharged water containing resist residues removed from the board by means of the electrolyzed alkaline water, to acidify the discharged water to a pH of at most 4.5, and then the resist residues are collected and recovered by means of a filter (hereinafter referred to as Step 5 and/or Step 6). The basis of the sixth aspect of the present invention resides in that at least “Step 2 and Step 5” or at least “Step 4 and Step 6′ are combined.

According to the sixth aspect of the present invention, since the characteristic of the electrolyzed water that it tends to return to neutral is utilized, it is easy to return the electrolyzed alkaline water to neutral or to change it to acidic condition by lowering the pH, and since no chemical is used, the load on environment is low. Further, the resist residues tend to agglomerate in an acidic discharged water with the pH of at most 4.5, and precipitate therein, whereby the recovery with a filter can be made easily.

Here, the Step 5 and Step 6 may be made into a common one step by using a common acidification tank as mentioned below.

The seventh aspect of the present invention is a method wherein a neutral or weekly acidic liquid having a pH of 4 to 7 and a residual chlorine concentration of 800 to 4,000 ppm, is added to the resist discharged water which has passed through a filter and contains the rest of resist residues, so as to conduct oxidative decomposition treatment of the residual organic substances contained in the resist residues, and at the same time, the residual chlorine concentration in the discharged water is diluted to about 20 ppm and the pH thereof is adjusted to a range of 6 to 7.5 for reutilization as an industrial water (hereinafter referred to as Step 7). The basis of the seventh aspect of the present invention resides in that at least “Step 2, Step 5 and Step 7” or at least “Step 4, Step 6 and Step 7” are combined as mentioned above.

According to the seventh aspect of the present invention, in is not necessary to conduct a pollution-free treatment by use of a large-sized treatment tank with high costs for treatment, which has been required for conventional treatment of discharged water with chemicals. And, it becomes possible to reutilize the discharged water as common industrial water without increasing the load on environment. Further, not only the resist removed from the board but also the sodium carbonate solution or sodium hydroxide solution used for swelling of the resist, are circulated in a closed system, and the lifetime can be prolonged, whereby the load on environment can further be reduced.

Here, the Step 7 may be conducted subsequent to each of the Step 5 and the Step 6, or as mentioned below, such may be made into a common one step by using a common tank for decomposing the residual organic substances.

The eighth aspect of the present invention is a method wherein the electrolyzed alkaline water used in the method has a pH of at least 10, an oxidation-reduction potential of −150 to −850 mV and a surface tension of at most 67 dyne/cm. According to this embodiment, since no corrosion of a copper film by alkaline chemicals is occurred, only rinsing with water is used without using a strongly acidic chemical for the neutralization treatment of the copper film, whereby the load on environment can be reduced and the amount of chemicals used can also be reduced.

Even if the chemical and physical properties of the electrolyzed alkaline water used here depart from these numerical ranges, the object of the present invention can sufficiently be accomplished to some extent.

Among them, if the electrolyzed water is produced by using a water softener, the sodium concentration is raised and the developing properties are improved, such use being preferred.

Further, it is preferred that the electrolyzed alkaline water used for the removal of the cured resist is preliminarily heated to about 40 to 50° C. from the viewpoint of the peeling speed.

The board from which the uncured and cured resists are removed by means of the electrolyzed alkaline water, is then subjected to a drying treatment to produce a finished product. As the drying treatment, it is preferred that the moisture contents on the board surface is evaporated all at once by dry air or an air knife.

The ninth aspect of the present invention is a method wherein the electrolyzed acidic water used in the method has a pH of at most 3, an oxidation-reduction potential of 1,000 to 1,300 mV and a residual chlorine concentration of at most 15 ppm. According to this aspect, it can easily be conducted to acidify the used electrolyzed alkaline water and agglomerate the resin components in the discharged water after the development of the photosensitive resist and/or the peeling for removal thereof. Since the discharged water after the agglomeration of the resin components is neutralized by a reaction with organic substances, a treatment without the load on environment can be realized.

Even if the chemical and physical properties of the electrolyzed acidic water used here depart from these numerical ranges, the object of the present invention can sufficiently be accomplished to some extent, although the efficiency may sometimes be a little lowered.

If a compound containing no chlorine ions is used as an electrolyte, the residual chlorine concentration does not exceed the above ranges. However, when a compound which is capable of liberating chlorine ions when dissolved in water is used as an electrolyte, it is necessary to adjust the addition amount of said compound so that the residual chlorine concentration will be in the above range, for example, it is preferred to add in an amount of at most 0.1% (wt %)

The tenth aspect of the present invention is a method for producing a printed-wiring board wherein the electrolyzed alkaline water and/or the electrolyzed acidic water is obtained by electrolyzing water containing, as an electrolyte, a compound which is capable of liberating ions of at least one type selected from chlorine ions, sulfuric ions, carbonate ions and hydroxyl ions when dissolved in water.

As the electrolyte, a salt which becomes neutral when dissolved in water is preferred. For example, sodium chloride, potassium chloride, sodium sulfate, potassium sulfate and ammonium sulfate may be mentioned. Further, a salt which becomes alkaline when dissolved in water may be used. For example, sodium carbonate and potassium carbonate may preferably be used.

If it is attempted to obtain the electrolyzed alkaline water or electrolyzed acidic water having the pH as defined in the present invention, it is necessary to add a relatively large amount of the electrolyte or raise the voltage. However, when a compound containing chlorine ions is used as the electrolyte, if the addition amount is increased, the residual chlorine concentration in the resulting electrolyzed acidic water is increased. Accordingly, it is preferred to conduct electrolysis with a high voltage while suppressing the addition amount of the electrolyte. On the other hand, when a compound containing sulfate ions, carbonate ions and ammonium ions is used as the electrolyte, since the residual chlorine concentration can be made substantially 0 ppm, the electrolysis can be conducted with a relatively low voltage by increasing the addition amount of the electrolyte.

Namely, when a compound which is capable of liberating chlorine ions is used as the electrolyte, it is preferred to conduct the electrolysis at 30 to 70V while reducing the addition amount as low as possible. And, when sulfate ions, carbonate ions and ammonium ions are used as the electrolyte, the electrolysis can be made at 5 to 70V.

When the residual chlorine concentration in the electrolyzed acidic water exceeds 15 ppm, chlorine gas evolves or untreated metal chloride content contained in the discharged water increases, such being undesirable. Further, when the electrolyzed acidic water is used for removal of corrosion by alkaline chemicals in the development or peeling step of the printed-wiring board or for acid washing on the copper surface, the copper ions eluted in the electrolyzed acidic water bond to chlorine ions to form copper chloride and suspend the electrolyzed acidic water. When the electrolyzed acidic water is continuously used as it is, by the bonding with carbon dioxide gas in air, a basic carbonate (a so-called verdigris) is formed, and the copper surface is in contrary oxidized, such being problematic.

The eleventh aspect of the present invention is a method wherein the conductive pattern of the printed-wiring board is formed as copper pattern electrodes. According to the eleventh aspect of the present invention, it is possible to produce an excellent printed-wiring board with a high integration, such as ultra LSI, which has a fine conductive copper electrode pattern with a high density.

### BRIEF EXPLANATION OF THE DRAWINGS

FIG. 1 is a view illustrating an example of the treatment step system of the method of the present invention.

FIG. 2 is a view illustrating an example of the treatment step system of the method of the present invention.

FIG. 3 is a schematic view illustrating an example of an apparatus for production of the electrolyzed ionic water to be used in the present invention.

### BEST MODE FOR CARRYING OUT THE PRESENT INVENTION

In the present invention, the printed-wiring board is developed with the object of obtaining a printed-wiring board on which a conductive pattern (electrodes) mainly made of copper or a material of copper as the main component is formed. However, it should be mentioned that the material of the conductive pattern is not necessarily restricted to copper, and other materials may be used.

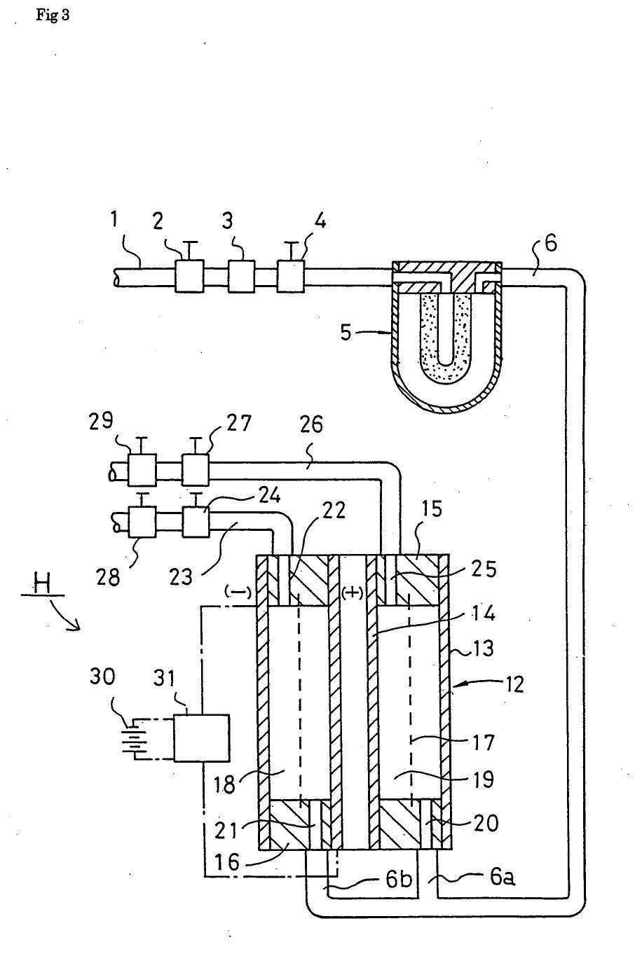

The electrolyzed alkaline water and electrolyzed acidic water used in the present invention are basically a strongly alkaline water and a strongly acidic water obtainable by electrolysis of water in an electrolysis tank. FIG. 3 shows an example of an apparatus using an electrolysis tank having an anode, a cathode and an ion permeable diaphragm disposed therebetween as the apparatus for producing preferable electrolyzed water to be used in the present invention.

In the present invention, the removal treatment of the resist with the electrolyzed alkaline water is generally preferably made by showering of the electrolyzed alkaline water from the viewpoints of productivity and costs of facilities. However, in the case of showering, there is a problem that the electrolyzed alkaline water is neutralized by the contact with the carbon dioxide gas in the air at the time of showering. Accordingly, a method wherein the board is immersed in the electrolyzed alkaline water and treated with ultrasonic waves, etc., may be mentioned.

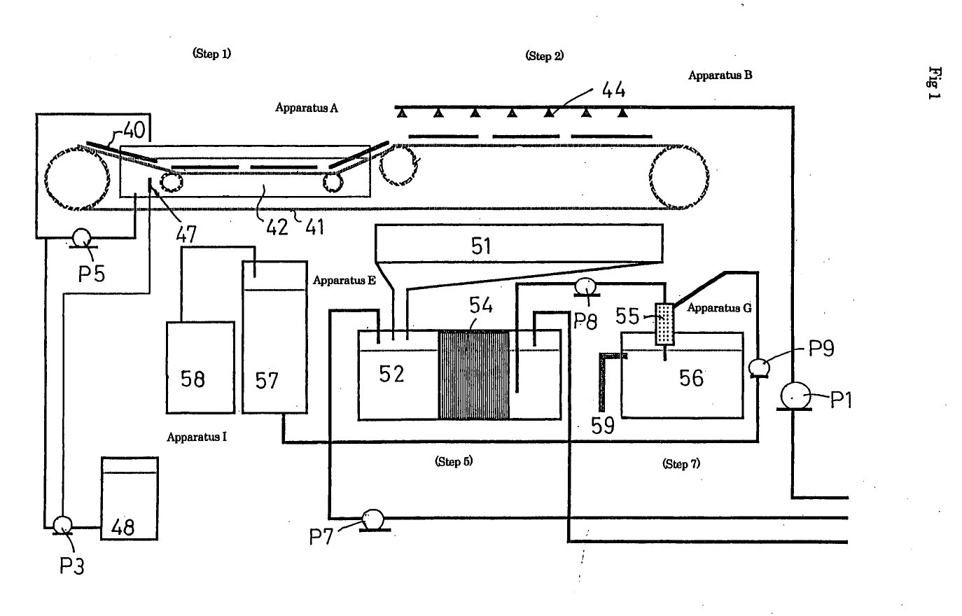

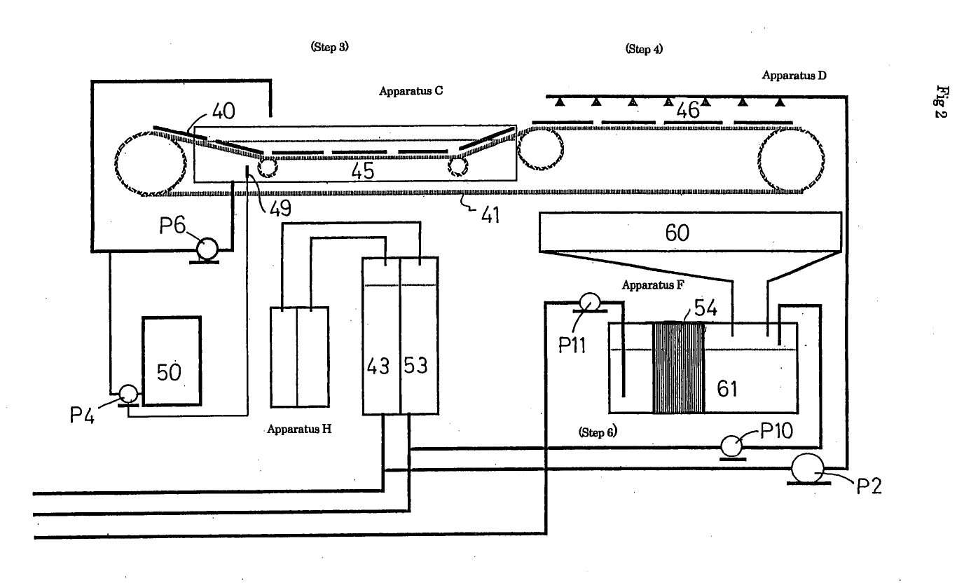

FIG. 1 and FIG. 2 show an example schematically illustrating the preferred whole system for carrying out the present invention. In FIG. 1 and FIG. 2, the flow chart of the treatment of the printed-wiring board in this system is continued from FIG. 1 to FIG. 2 in the case of a step for forming a pattern, and completed in FIG. 1 in the case of a step of forming an insulation layer.

Namely, the preferred whole system is basically comprised of a treatment apparatus A for swelling the uncured resist with an alkaline chemical such as sodium carbonate, to be used in Step 1; a treatment apparatus B for removing the uncured resist with the electrolyzed alkaline water, to be used in Step 2; a treatment apparatus C for swelling the cured resist with an alkaline chemical such as a sodium hydroxide solution, to be used in Step 3; a treatment apparatus D for removing the cured resist with the electrolyzed alkaline water, to be used in Step 4; a treatment apparatus E for neutralizing or acidifying the discharged water from the treatment apparatus B and collecting and recovering the resist residues, to be used in Step 5; a treatment apparatus F for acidifying the discharged water from the treatment apparatus D and collecting and recovering the resist residues, to be used in Step 6; a reutilization apparatus G for decomposing residual organic substances in the discharged water and reutilizing it as industrial water, to be used in Step 7; an apparatus H for producing preferred electrolyzed water to be used in the present invention; and an apparatus I for producing preferred hypochlorous acid of a high concentration to be used in the present invention.

In this system, the first aspect of the present invention can be carried out by at least the apparatus B or the apparatus D and the apparatus H; the second aspect can be carried out by at least the apparatus A, the apparatus B and the apparatus H; the third aspect can be carried out by at least the apparatus C, the apparatus D and the apparatus H; the fourth aspect can be carried out by at least the apparatus B, the apparatus E and the apparatus H, or by at least the apparatus D, the apparatus F and the apparatus H; the fifth aspect can be carried out by at least the apparatus G and the apparatus I in addition to the apparatuses for carrying out the fourth aspect; and the sixth and seventh aspects can be carried out basically by at least the apparatus H in the above.

At first, the apparatus H for producing the preferred electrolyzed water used in the present invention as shown in FIG. 3, will be described. This apparatus H is mainly constituted by a raw water lead-in tube 1, a connecting pipe 6, a filter tank 5 disposed in the middle thereof, an electrolysis tank 12, an electrolyzed alkaline water lead-out pipe 23 and an electrolyzed acidic water lead-out pipe 26. Here, the raw water lead-in pipe 1 is connected to the filter tank via a pressure reducing valve 2, a pressure switch 3 and an electromagnetic valve 4, and further connected to the electrolysis tank 12 via the connecting pipe 6.

The electrolysis tank 12 has a structure wherein a cathode 13 made of a cylindrical stainless steel electrode and an anode 14 made of a cylindrical titanium+platinum electrode having a diameter smaller than that of the cathode 13, are disposed concentrically, and the upper and lower end faces thereof are sealed with annular covers 15, 16. Further, between the cathode 13 and the anode 14, a diaphragm 17 likewise having a cylindrical shape is disposed, both ends thereof being supported by covers 15, 16, and the inside of the electrolysis tank 12 is partitioned into a cathode chamber 18 at the outside and an anode chamber 19 at the inside at the proportion of a volume ratio of 45:55. This diaphragm 17 allows cations to permeate from the anode chamber 19 side to the cathode chamber 18 side and anions to permeate from the cathode chamber 18 side to the anode chamber 19 side.

The front end of the connecting pipe 6 is branched into 6a, 6b, and the pipe 6a is connected to a lead-in passage 20 towards the cathode chamber 18 disposed in the cover 16 at the bottom portion of the electrolysis tank 12, and another pipe 6b is connected to a lead-in passage 21 towards the anode chamber 19 disposed in the cover 16. Both of 6a, 6b have the same diameter and a structure wherein a raw water is led therein at the same pressure.

Further, on the cover 15 at the upper portion of the electrolysis tank 12, a lead-out passage 22 for taking out the electrolyzed alkaline water from the cathode chamber 18 is disposed, and an electrolyzed alkaline water lead-out pipe 23 is connected thereto, through which the electrolyzed alkaline water is supplied via an electromagnetic valve 24 and a flow rate control valve 28. Further, on the cover 15 at the upper portion of the electrolysis tank 12, a lead-out passage 25 for taking out the electrolyzed acidic water from the anode chamber 19 is disposed, and an electrolyzed acidic water lead-out passage 26 is connected thereto, through which the electrolyzed acidic water is supplied via an electromagnetic valve 27 and a flow rate control valve 29.

By the above flow rate control valve 29, 29, the discharge amount from the anode chamber 19 and the discharge amount from the cathode chamber 18 are adjusted so that the ratio of these discharge amounts will be 4.5:5.5. Here, in the electrolysis tank 12, a power source 30 for supplying electric power to the anode 14 and the cathode 13, and a controller 31 for controlling the electric power from the power source 30 are disposed. Further, although not shown in the drawings, in the anode chamber 19, eight round bars made of vinyl chloride having a diameter of about 2 mm, are disposed at a spacing of 3 cm, in parallel along the axial direction of the anode 14.

Accordingly, when the raw water is led from the raw water lead-in pipe 1 to the filter tank 5 via the pressure-reducing valve 2, the pressure switch 3 and the electromagnetic valve 4, particulates having a size of at least 10 μm in the raw water are captured so that the diaphragm 17 will not be clogged, and the raw water pass the filter tank and flow out of the connecting pipe 6.

The raw water flowing out of the connecting pipe 6 is branched into the branch pipes 6a, 6b, and flow in the cathode chamber 18 and the anode chamber 19 of the electrolysis tank 12 at the same pressure and the same flow rate, respectively. The influent raw water into the anode chamber 19 flow within the anode chamber 19 at a high flow rate by the vinyl chloride round bars. In the electrolysis tank 12, electric voltage is applied between the anode 14 and the cathode 13, by which electrolysis of the raw water is carried out. As the preferred electrolysis conditions, the electric power is adjusted by the controller 31 so that the electric voltage will be 5 to 70V, more preferably 30 to 70V, and the electric current will be 16 to 25A, and the flow rate is adjusted so that the electrolyzed acidic water will be discharged from the anode chamber 19 at a flow rate of 1 to 2 liters/minute and the electrolyzed alkaline water will be likewise discharged from the cathode chamber 18 at a flow rate of 1 to 0.2 liters/minute.

Here, when the concentration of ions dissolved in the raw water is too low, it is preferred to conduct the electrolysis by the above electrolysis apparatus after adding the electrolyte to the raw water. As such an electrolyte, a compound which is capable of liberating at least one selected from chlorine ions, sulfate ions, carbonate ions, ammonium ions, hydroxyl ions, etc., when dissolved in water, is preferably used. Particularly, sodium chloride, potassium chloride, sodium sulfate and ammonium sulfate as neutral salts, and sodium carbonate and potassium carbonate as alkali salts, may preferably be used.

By the above methods, the electrolyzed alkaline water having the pH of at least 10, the oxidation-reduction potential of −150 to −850 mV, and the surface tension of at most 670 dyne/cm, and the electrolyzed acidic water having the pH of at most 3, the residual chlorine concentration of at most 15 ppm and the oxidation-reduction potential of 1,000 to 1,300 mV, to be used in the present invention, can be produced, respectively.

In this instance, when a compound which is capable of liberating chlorine ions is added as the electrolyte, it is preferred to adjust the addition amount of the electrolyte as small as possible, for example, 0.1% (wt %) or less, so that the residual chlorine concentration will be at most 15 ppm, followed by electrolysis at a voltage of 30 to 70V. Further, when a compound which is capable of liberating sulfate ions, carbonate ions, ammonium ions, hydroxyl ions, etc. is used as the electrolyte, the residual chlorine concentration can be made substantially 0 ppm, whereby the addition amount of the electrolyte can be increased and the electrolysis can be made at a voltage of 5 to 70V.

Further, the apparatus I for producing the hypochlorous acid of a high concentration preferably used in the present invention will be described in detail. In this apparatus I, a diaphragm is disposed between an anode and a cathode to separate an electrolysis tank into an anode chamber and a cathode chamber, and using this electrolysis tank, an aqueous sodium chloride solution is electrolyzed by means of the diaphragm interposed, hypochlorous acid of a high residual (effective) chlorine concentration can be generated from the anode side. An example thereof is described in detail in JP-A-2-149395.

By the above method, the hypochlorous acid of a high concentration, having the pH of 4 to 7, particularly the pH of 4.2 to 6, and the residual chlorine concentration of about 800 to 4,000 ppm, preferably used in the present invention, is produced. Here, the residual chlorine concentration is the one obtained by adding a free radical chlorine “hypochlorous acid (HClO), chlorine (Cl₂) and hypochlorous ions (ClO⁻)” to a bound chlorine (NCl₂, NHCl₃, etc.). Particularly, the free radical chlorines all exist in the form of hypochlorous acid (HClO) within the pH range of 4.5 to 6.

Next, an embodiment wherein the present invention is applied to the steps of the removal of the uncured resist and the removal of the cured resist in the production steps of the printed-wiring board, will be described on the basis of FIG. 1 and FIG. 2.

The photosensitive resist is coated on the surface of a board on which a copper film or films are formed on both sides or in multi-layer form by e.g. plating. Further, a board 40 which is subjected to an exposure step through a mask (hereinafter referred to simply as board) is placed on a ring-roller conveyor 41, and immersed in a sodium carbonate solution tank 42 in which the temperature and the concentration are adjusted by the treatment apparatus A as the Step A, whereby the uncured resist is swelled. Here, as the sodium carbonate solution, the one that is heated to the temperature of about 30° C. and adjusted to the concentration of about 1%, is adequately used. The immersion time of about 30 to 60 seconds is sufficient.

The sodium carbonate solution is used for the purpose of swelling the uncured resist only, and not for dissolution. Accordingly, the sodium carbonate solution is measured with a concentration sensor 47, and automatically supplied from a sodium carbonate solution tank 48 to a sodium carbonate solution tank 42 by a pump P5 so that a constant concentration can be maintained. Further, since no uncured resist is dissolved in the sodium carbonate solution tank 42, there is no necessity of discharging it to the outside, and it can be used by circulation by a pump 3 only by a treatment, for example, supplying the consumed amount or detecting the lowering of the pH and supplying the sodium carbonate.

The board on which the uncured resist is swelled is then transported to the treatment apparatus B as the Step 2, and the cleaning treatment of the uncured resist and the peeling treatment of the uncured resist (at the same time, development of the cured resist is carried out) by the electrolyzed alkaline water are carried out.

The electrolyzed alkaline water is one having the above properties, produced by an electrolyzed water-producing apparatus H as illustrated in FIG. 3 in detail. The one ejected from the cathode side of the electrolyzed water-producing apparatus H and stored in the electrolyzed alkaline water-storing tank 43, is pressurized by a pump P1 and blown from a showering apparatus 44 disposed at the upper portion of the treatment apparatus B. Here, as the electrolyzed alkaline water, the one heated to the temperature of about 40 to 50° C. is effectively used, and the blowing time of about 15 to 60 seconds (depends on the image) is sufficient.

The board for the formation of pattern for which this step is finished, is once transported from this system, and subjected to an etching treatment by an independent etching apparatus, and then returned to this system again.

Here, when an insulation layer is formed on the board, the photosensitive resin is cured by the above steps and becomes an insulation layer. And, the board on which the insulation layer is formed, is transported from this system, and subjected to subsequent treatments depending on the purposes.

The board 40 for the formation of pattern on which the uncured resist is removed and the copper film is subjected to the etching treatment, is then transported to the treatment apparatus C in the Step 3. In the treatment apparatus C, the board is immersed in a sodium hydroxide solution tank 45 made of stainless steel in which the temperature and the concentration are adjusted, and the cured resist is swelled. Here, as the sodium hydroxide solution, the one which is heated to the temperature of about 40 to 50° C. and has the concentration of about 3%, is adequately used, and the immersion time of about 30 to 60 seconds is sufficient.

The sodium carbonate solution is used for the purpose of swelling the uncured resist only, and not for dissolution. Accordingly, the sodium carbonate solution is measured with a concentration sensor 49, and automatically supplied from a sodium carbonate solution tank 50 to a sodium carbonate solution tank 45 by a pump P6 so that a constant concentration can be maintained. Further, since no uncured resist is dissolved in the sodium carbonate solution tank 45, there is no necessity of discharging it to the outside, and, as in the case of the development, it can be used by circulation by a pump P4 only by a treatment, for example, supplying the consumed amount or detecting the lowering of the pH and supplying the sodium carbonate.

The board on which the uncured resist is swelled is then transported to the treatment apparatus D as the Step 4. In the transportation from the treatment apparatus C to the treatment apparatus D, it is desirable that the board is taken out of the sodium hydroxide solution tank 45 before the swelled cured resist is dissolved in the sodium hydroxide solution.

In the treatment apparatus D, for the removal of the swelled cured resist, a cleaning treatment of the cured resist with the electrolyzed alkaline water, and a peeling treatment are carried out.

The electrolyzed alkaline water may be the same as the one for the electrolyzed alkaline water used in the Step 2. Namely, the one having the above properties, produced by the electrolyzed water-producing apparatus H as illustrated in FIG. 3 in detail and stored in the electrolyzed alkaline water-storing tank 43, is pressurized by a pump P2 and blown from a showering apparatus 46 disposed at the upper portion of the treatment apparatus D. Here, in this instance also, as the electrolyzed alkaline water, the one heated to the temperature of about 40 to 50° C. is effectively used, and the blowing time of about 15 to 60 seconds is sufficient.

The removal of the resist of the board is basically completed as above.

On the other hand, the treatment of the electrolyzed alkaline water used in the step for the removal of the resist and discharged, is important. In the present invention, since the electrolyzed alkaline water used in each step is an electrolyzed water and not chemicals, the discharged water is basically water as itself, and its treatment is extremely easy. This treatment step will be described below.

First, in FIG. 1, as the Step 5, an apparatus E shows an example of an apparatus wherein resist residues are collected and recovered from the discharged water mainly composed of the electrolyzed alkaline water containing the resist residues generated as the result of the treatment with the electrolyzed alkaline water, as the basis of the present invention in the treatment apparatus B. In the treatment apparatus E, the discharged water mainly composed of the electrolyzed alkaline water containing the resist residues, flows into a hopper 51 disposed at the lower portion of the treatment apparatus E and stored in an acidifying tank 52. In order to treat this discharged water, the electrolyzed acidic water is poured in the acidifying tank 52, and mixed, and then the discharged water is acidified.

The electrolyzed acidic water is the one having the above properties, produced by the electrolyzed water-producing apparatus H as in the above. The electrolyzed alkaline water is ejected from the anode side of the electrolyzed acidic water-producing apparatus H and stored in the electrolyzed acidic water-storing tank 53, and it is supplied to the acidifying tank 52 of the apparatus E by a pump P7.

In the acidifying tank 52, the pH is adjusted to an acidic range of at most 4.5 so that the floating resist residues can readily be agglomerated and precipitated. The residues are thereby easily collected and recovered by a filter 54.

Then, since the discharged water which has passed through the filter 54 contains resist residues as fine particles of the organic resist which raise the COD and BOD values, it is necessary to decompose them and make them harmless so that the discharged water can be treated in a short time and further recycled at the level of city water.

An example of an apparatus for this purpose is shown as the Step 7 by an apparatus G in FIG. 1. This apparatus G is mainly comprised of a residual organic substances-decomposing tank 56.

First, the discharged water which has passed through the filter 54 of the acidifying tank 52 and contains resist residues as the fine particles of the organic resist, is introduced into a treatment tank 56 by a pump P8. Further, a hypochlorous acid ionic water of a high concentration having the residual chlorine concentration of 800 to 4,000 ppm and the pH of 4 to 7, is likewise introduced from a tank 57 of a hypochlorous acid ionic water of a high concentration to a treatment tank 56 by a pump P9, followed by mixing with the discharged water by a mixer 55 of the hypochlorous acid ionic water of a high concentration. Further, the hypochlorous acid ionic water of a high concentration is produced by a machine 58 for producing the hypochlorous acid ionic water of a high concentration, and stored in the tank 57 of the hypochlorous acid ionic water of a high concentration.

By the above mixing, the hypochlorous acid ionic water of a high concentration is diluted, and the organic fine particles of the resist contained in the discharged water at the time of dilution, is brought into contact with the hypochlorous acid of a high concentration and subjected to oxidative decomposition.

And, the mixed solution is treated by a batch processing by the treatment (decomposition of residual organic substances) tank 56 for oxidative decomposition, and the electrolyzed alkaline water is added thereto if the case requires to adjust the pH to 6 to 7.5, and then the mixed solution is taken out from a discharging pipe 59, and if necessary, passed through a filter to remove scams, and then supplied to an industrial water tank, etc. and reused as the industrial water.

On the other hand, in FIG. 2, an apparatus F shows as the Step 6, an example of an apparatus for collecting and recovering resist residues from the discharged water mainly composed of the electrolyzed alkaline water containing the resist residues, produced as the result of the treatment with the electrolyzed alkaline water, which is also the basis of the present invention in the treatment apparatus D.

Namely, the electrolyzed alkaline water blown to the board 40 by the showering apparatus 46, flows as the discharged water through a hopper 60 of the treatment apparatus F, and is collected to a circulation tank 61. In order to treat this discharged water, the electrolyzed acidic water is supplied from the electrolyzed acidic water-storing tank 53 by a pump P10, and mixed to acidify the discharged water. And, in order to collect large peeled pieces, the discharged water is treated by a deposit remover 54.

And, the discharged water from which the large peeled pieces are removed by a deposit remover 54, is transported to the acidifying tank 52 by a pump P11, and mixed with the discharged water which has passed through the filer 54 of the acidifying tank 52. This discharged water is as mentioned above, introduced to the treatment tank 56 by the pump P8 and treated in the same manner as above.

These methods are an oxidative treatment method in which the electrolyzed acidic water is supplied to the treatment apparatus F in which the alkaline discharged water is stored and by which the load on environment can easily be reduced to a great extent; an oxidative-decomposition treatment method in which the residual organic substances contained in the resist residues are subjected to oxidative decomposition by the electrolyzed neutral water of a high residual chlorine concentration and by which the load on environment can easily be reduced to a great extent; and an extremely effective method by which the removal of the resist and the treatment of the accompanying discharged water can be made integrally.

### EXAMPLES

Production of Electrolyzed Alkaline Water and Electrolyzed Acidic Water

Using city water as the raw water and the apparatus H as shown in FIG. 3, electrolysis was conducted under the conditions of the voltage of 60V, electric current of 20A, the flow rate of an electrolyzed acidic water of 2 liters/minute, and the flow rate of an electrolyzed alkaline water of 2 liters/minute to produce an electrolyzed acidic water and an electrolyzed alkaline water. With respect to the thus obtained electrolyzed acidic water and electrolyzed alkaline water, and the city water, the surface tension, the oxidative-reduction potential (ORP), the residual chlorine concentration (ppm) and the pH were measured. The results are indicated in Table 1.

TABLE 1

| | | Oxidative- | Residual | |
|---|---|---|---|---|
| | Surface | reduction | chlorine | |
| | tension | potential | concentration | |
| | (dyne/cm) | (mV) | (ppm) | pH |
| Electrolyzed | 62.4 | −855 | 0 | 11.43 |
| alkaline water | | | | |
| Electrolyzed | 63.4 | +1108 | 12 | 2.31 |
| acidic water | | | | |
| City water | 72.2 | +352 | 0.5 | 7.84 |

Here, the pH and the oxidative-reduction potential were measured with a pH/ion meter F-24 manufactured by Horiba, Ltd. And, as the surface tension, the surface tension at 20 was measured by a Du Nouy tensiometer manufactured by Taihei Rika Kogyo K. K.

From the results in Table 1, it is found that the electrolyzed acidic water and the electrolyzed alkaline water have low surface tensions as compared with the city water, and it is also found that the wettability to the resist is excellent and the removal effect can rapidly be exhibited.

Production of a Printed-Wiring Board

A copper film having a thickness of 12 μm was formed by a plating method on the surface of a board for print wiring (material of board: glass epoxy resin), and a dry film manufactured by Hitachi Chemical Company, Ltd. was laminated on the surface. And, a mask having a pattern is put on the board, followed by irradiation with ultraviolet rays.

### Example 1

The mask was detached from the board, and the board was immersed for a swelling treatment in a tank made of vinyl chloride in which sodium carbonate solution is filled instead of the treatment apparatus A as shown in FIG. 1. The swelling treatment was conducted by immersing the board in a 1% sodium carbonate solution at ordinary temperature for 60 seconds.

Then, while transporting the board on a conveyer, a removal treatment of the resist was conducted with the electrolyzed alkaline water by the treatment apparatus B with the electrolyzed alkaline water as shown in FIG. 1.

In this treatment, using the electrolyzed alkaline water as indicated in Table 1, showering was conducted at a rate of 90 liters/minute for 60 seconds.

Then, the board was taken out from the conveyer, and drained, and then the condition of the removal of the resist (uncured portions and cured portions) was observed and evaluated.

Method of Observation and Results of Observation

1) breakage of tent of through hole, 2) edge roughness, and 3) increase or decrease of the line width, were observed by use of a microscopic monitor of North Eastern Industrial Research Center in shiga-ken japan.

Method of Evaluation and Results of Evaluation

Confirmation was conducted on the presence or absence of breakage of tent of through hole, edge roughness, and decrease of the line width.

Further, in order to evaluate as to whether or not there are remains of the development of the dry film, an etching treatment was conducted by a separately prepared etching apparatus, to remove the copper film at the portions where the uncured resist was removed.

As a result, it was confirmed that there is no resist other than the patterned images on the surface i.e. there is no remains of the development.

Then, the board which was subjected to development and etching and had the cured resist remaining on the surface, was immersed in a vinyl chloride tank in which a sodium hydroxide was charged, followed by a swelling treatment. The treatment was conducted by immersing it in a 3% sodium hydroxide solution at 40° C. for 30 seconds.

Then, while transporting the board as it is on a conveyer, the removal treatment of the cured resist was conducted with the electrolyzed alkaline water by a treatment apparatus D with the electrolyzed alkaline water as shown in FIG. 2.

In this treatment, using the electrolyzed alkaline water as indicated in Table 1, showering was conducted at a rate of 90 liters/minute for 60 seconds.

Then, the board was taken out from the conveyer, and dried, and then the surface properties of the board were observed and evaluated. The results are as follows:

Method of Observation and Results of Observation

Confirmation was conducted on the presence or absence of the resist residues and the adhesion of development scum by using the above microscopic monitor.

Method of Evaluation and Results of Evaluation

As the result, it was confirmed that the resist was completely peeled off.

From such results, it was found that the thus obtained board is sufficiently applicable to practical use. Further, with respect to 30 boards, similar treatment was conducted to inspect the occurrence of defects.

As the result, no defect (remains of development=remains of etching, and adhesion of peeling residuum to the surface) was found.

### Example 2

The discharged water of the electrolyzed alkaline water generated in the treatment step by use of the electrolyzed alkaline water in the apparatuses B and D utilized for the above-mentioned development and peeling tests, was stored in an acidifying tank, and mixed with the electrolyzed acidic water in the acidifying tank for oxidation treatment. The discharged water of the electrolyzed alkaline water contained the uncured resist removed from the board in an amount of at least 11 m² as calculated as a 35 μm thick dry film.

The oxidation treatment was conducted by use of the electrolyzed alkaline water as indicated in Table 1 in the following procedure.

(1) 50 liters of the discharged water recovered from the treatment tanks B and D was prepared.

(2) 65 liters of the discharged water of the electrolyzed strongly acidic water (pH 2.24) was added to 50 liters of the discharged water.

(3) further 10 liters was added to adjust the pH to at most 4.5.

(4) it was confirmed that the pH was 4.18.

(5) after stirring for 30 minutes, the liquid was left to stand still, whereupon agglomeration and precipitation of the photosensitive resin occurred, and the resin components precipitated at the bottom of the stirring container.

Then, the discharged water for which the oxidation treatment was completed was passed through a filter to separate and remove the large particles of the resist. The discharged water which have passed through the filter was subjected to the oxidative-decomposition treatment and neutralization treatment of the residual organic substances in the following procedure.

(6) 50 liters of the discharged water which has passed through the filter was once stored in the oxidative-decomposition treatment tank.

(7) hypochlorous acid of 2,500 ppm was diluted to 10 times i.e. 250 ppm, and 30 liters thereof was poured in the above tank.

(8) the discharged water was stirred for 60 minutes and left to stand still, and it was filtrated through a filter of 10 μ and stored in a separately prepared tank.

(9) compressed air was blown for 5 minutes, and the pH was measured to find that the pH was 5.1, and then 10 liters of the electrolyzed alkaline water (pH 10.6) was added and the compressed air was blown for further 5 minutes, whereupon the pH was 6.94, and the treatment was therefore stopped.

In the above, as the electrolyzed acidic water, the one having the pH of 5 and the residual chlorine concentration of about 2,500 ppm, was used.

The thus obtained discharged water was substantially neutral i.e. pH was about 7.0, and no heavy metals which bring about adverse effects to the board surface was contained, and it can therefore be reused sufficiently as the industrial water.

### INDUSTRIAL APPLICABILITY

As mentioned above, according to the present invention, the resist formed in the production steps of the printed-wiring board, and the photosensitive insulation layer are developed and/or treated for removal with the electrolyzed alkaline water. Accordingly, basically, the amount of the conventional chemicals (sodium carbonate and sodium hydroxide) can be remarkably reduced, and the development of the resist, the removal treatment thereof, and the development of the photosensitive resin layer can be conducted.

Further, it becomes possible to simplify the treatment of the discharged water, reutilize the water, and reduce the load on environment to a great extent, which used to be difficult by the conventional development and removal treatments of the resist, etc. by means of chemicals. Namely, it is possible to conduct efficiently the development of the resist, etc. and the removal treatment thereof, and at the same time, serves also as the measurement of the discharged water generated during these steps.

1. A method for producing a printed-wiring board, which is characterized by that in production steps of a printed-wiring board, development of a photosensitive resist and/or removal thereof, or formation of a photosensitive insulation layer is conducted with an electrolyzed alkaline water.

2. The method for producing a printed-wiring board according to claim 1, wherein removal of an uncured resist is conducted with the electrolyzed alkaline water.

3. The method for producing a printed-wiring board according to claim 2, wherein the removal of the uncured resist is conducted by swelling the uncured resist with an alkaline chemical and then removing the uncured resist with an electrolyzed alkaline water.

4. The method for producing a printed-wiring board according to claim 1 or 2, wherein the removal of the cured resist is conducted with the electrolyzed alkaline water.

5. The method for producing a printed-wiring board according to claim 4, wherein the removal of the cured resist is conducted by swelling the cured resist with an alkaline chemical and then removing the cured resist with the electrolyzed alkaline water.

6. The method for producing a printed-wiring board according to any one of claims 1 to 5, wherein an electrolyzed acidic water is blended with a resist discharged water containing resist residues removed from the board by means of the electrolyzed alkaline water, to acidify the discharged water to a pH of at most 4.5, and then the resist residues are collected and recovered by means of a filter.

7. The method for producing a printed-wiring board according to any one of claims 1 to 6, wherein a neutral or weekly acidic liquid having a pH of 4 to 7 and a residual chlorine concentration of 800 to 4,000 ppm, is added to the resist discharged water which has passed through a filter and contains a rest of resist residues, so as to conduct oxidative decomposition treatment of the residual organic substances contained in the resist residues, and at the same time, the residual chlorine concentration in the discharged water is diluted to about 20 to 60 ppm and pH thereof is adjusted to a range of 6 to 7.5 for reutilization as an industrial water.

8. The method for producing a printed-wiring board according to any one of claims 1 to 7, wherein the electrolyzed alkaline water is an electrolyzed alkaline water which has pH of at least 10, an oxidation-reduction potential of −150 to −850 mV and a surface tension of at most 67 dyne/cm.

9. The method for producing a printed-wiring board according to any one of claims 6 to 8, wherein the electrolyzed acidic water is an electrolyzed acidic water which has pH of at most 3, an oxidation-reduction potential of 1,000 to 1,300 mV and a residual chlorine concentration of at most 15 ppm.

10. The method for producing a printed-wiring board according to claim 8 or 9, wherein the electrolyzed alkaline water and/or the electrolyzed acidic water is obtained by electrolyzation of water containing, as an electrolyte, a compound which is capable of liberating ions of at least one type selected from chlorine ions, sulfuric ions, carbonate ions and hydroxyl ions when dissolved in water.

11. The method for producing a printed-wiring board according to any one of claims 1 to 10, wherein the conductive pattern of printed-wiring board is a copper pattern.
